(19) United States
(12) Patent Application Publication
(10) Pub. No.: US 2016/0188938 A1
(43) Pub. Date: Jun. 30, 2016

(54) IMAGE IDENTIFICATION MARKER AND METHOD

(71) Applicant: Gideon SUMMERFIELD, Hammersmith, London Greater London (GB)

(72) Inventor: Gideon Summerfield, London (GB)

(21) Appl. No.: 14/911,267

(22) PCT Filed: Aug. 14, 2014
(86) PCT No.: PCT/GB2014/052496

§ 371 Date: Feb. 9, 2016

(30) Foreign Application Priority Data
Aug. 15, 2013 (GB) 1314642.8

(51) Int. Cl. G06K 7/10

(52) U.S. Cl. CPC G06K 7/10722

(57) ABSTRACT

A system and method for identifying the origin of photographic images and selecting photographic images according to the identified origin for inclusion in a set of photographic images employs a high contrast identifiable label disposable at one or more points in one or more sizes within the camera field of view for images of the label to be included in any photographic image. The label can be one of a plurality of different styles of each label. Each different label bears a unique identification code in the form of a decoder bull binary number. Each label also comprises an asymmetrical element. Photographic images are scanned to identify any labels. If labels are found, label images are adapted for size, flatness of face presentation and rotational orientation. The unique identification code is read as a sequence of binary digits provided by presence or absence of code elements. If the read code matches a pre-determined selected code, the photographic image upon which the label appears is accepted as an addition to a set of photographic images all relating to the predetermined code.

### FIELD OF THE INVENTION

The present invention relates to a system and method for automatically providing identification for a photographic image. The invention more closely relates to a system and method whereby images may automatically be sorted in order that photographic images can be collected together.

It is to be understood that photographic images are defined hereafter as including one, the other or both of still images and video images

### THE PRIOR ART

Although often quite costly, professional photographs and video from events, and of products and services in use, have long been widely used in marketing. The rise of digital photography and photo and video sharing, which has been accelerated dramatically by the spread of smart phones and broadband, has opened up a vast potential resource of additional content. Photos and videos like these, created by customers experiencing an event, service or product, are not only potentially low cost they also carry greater credibility than content created by the brand-owner themselves.

However, to gather such user-generated content has required the expense of marketing, first to reach the customer and then to incentivise them to actively contribute the content to the brand-owner, through mechanisms like competitions. So, while hundreds of thousands of photos and video are uploaded to the Internet every day, many from events or capturing products and services in use, very few are ever identified and exploited for marketing purposes.

To others, user-generated content represents a threat not an opportunity, one which is seen to undermine the value of official photo and videos from events. It is increasingly common for those attending high-value events to be asked not to take photos or video. But sharing of this material is widespread and identifying it to date has been a matter of chance or, for extremely high value content, a lot of legwork by specialist rights management businesses.

Systems that use printed labels that can be read for their identity data in order to indicate the presence of a specific product have been around since the invention of the barcode. And with the growing ubiquity of portable digital imaging and general purpose processing power, brought by the spread of the smart phone, their application has spread with solutions like the QR Code or Augmented Reality markers. All these, however, are designed to be read in real-time and at close proximity, from a couple of centimetres in the case of the former to perhaps a meter or two in the case of the later. These are not suitable for use in identifying photos and video taken at normal distances.

In the past there have been many proposals enabling photographic images to be identified. Attempts to automate gathering of socially shared user-generated imagery have been made which rely on the user adding specific metadata relating to a place and date from which an event may be inferred but which is typically not done.

International patent application WO2013074895 (A2) discloses automatic extraction of data from and tagging of a photo (or video) having an image of identifiable objects. A combination of image recognition and extracted metadata, including geographical and date/time information, is used to find and recognize objects in a photo or video. Upon finding a matching identifier for a recognized object, the photo or video is automatically tagged with one or more keywords associated with and corresponding to the recognized objects.

International patent application WO2012112449 (A1) discloses methods, systems, and apparatus, including computer programs encoded on a computer storage medium, for automatic event recognition and photo clustering. In one aspect, methods include receiving, from a first user, first image data corresponding to a first image, receiving, from a second user, second image data corresponding to a second image, comparing the first image data and the second image data, and determining that the first image and the second image correspond to a coincident event based on the comparing.

International patent application WO03043315 (A1) discloses digital cameras arranged at points of interest in a recreational venue to automatically photograph individuals participating in activities at such points in response to detection of identifying parameters uniquely to corresponding to respective individuals such as respective radio frequency identification (RFID) tag code. The photographs are automatically transmitted for storage in a database from which they may be accessed for viewing or printing upon presentation and recognition of the identifying parameter.

International patent application WO2011051091 (A1) discloses a method for automatically organizing photos into events. An event is defined as a set of photos taken at the same place and within the same time-span, showing a real-world occurrence. The method comprising the steps of segmenting a collection of photos using date, time, EXIF data known for the photo or performing object recognition. Correlating segments having similar date, time or GPS info or based on face or object recognition or a social graph. Providing meta-data to help to label and tag the events.

Swiss patent CH703915 (A2) discloses a process for stabilizing a relationship between two or more members of a dynamic social network. The system comprises a web platform hosted by one or more servers, a dynamic social network comprising several members, a visual identification code linked to a member, a support for the identification code, an optical device for detecting the code, a computerized device interfaced with the optical device and connected to the internet and a principal server for recognizing the code. The support can be an article of clothing. Independent claims are included for: a system for stabilizing a relationship between two or more members of a dynamic social network; a support for recognition code; and a support for visual identification code.

United States patent application US2013119123 (A1) discloses a photography database configured to interface with at least one camera and includes a memory to store pictures of distinct bar codes and of theme park guests in the order in which they were taken so that the distinct bar codes separate the respective pictures of the theme park guests. A processor is coupled to the memory to retrieve stored pictures based on the distinct bar codes being presented by the theme park guests by detecting the stored distinct bar code matching the distinct bar code presented by the theme park guest, and detecting a stored next distinct bar code that does not match the distinct bar code presented by the theme park guest. All pictures between the matching and non-matching stored distinct bar codes are retrieved. At least one display is coupled to the photography database for displaying the retrieved pictures.

US2012207349 shows a method in which a tag is affixed to a known individual that is to be identified within a known field of view of an image capture system. The tag is a physical tag comprising at least a known feature. Subsequent to affixing the tag to the individual, image data is captured within the known field of view of the image capture system, which is then provided to a processor. Image analysis is performed on the captured image data to detect the known feature. If this feature is detected, an occurrence of the known individual within the captured image data is identified.

It is known to take photographs, for example using a mobile phone, and submit these to a visual query search system such as shown in US2011125735. Each visual query submitted is processes by sending it to a plurality of parallel search systems, each implementing a distinct visual query search process. These parallel search systems may include techniques such as optical character recognition (OCR), facial recognition, product recognition, bar code recognition, object-or-object-category recognition etc.

A collection of photographs may be sorted or divided into subject-specific sets by a process shown in US2010266155. Before an event at which photographs are to be taken, information identifying some or all subjects is submitted to an automated facilitator. The facilitator generates slates comprising machine-scannable tags or codes, with each identified subject having a unique slate. At the event, for each subject a first photo is taken that includes the subject's slate; any number of photos is taken afterward. The photos are uploaded to the facilitator and scanned to identify the slates. Every photo that follows a slate is associated with the corresponding subject, until another slate is identified.

It is well known to analyze photographs or videos for textual information. For example, US2008175479 processes video signals containing video information related to a scene which may contain a vehicle license plate. WO2011159460 discloses a method whereby establishments are identified in geo-tagged images by extracting text phrases and comparing these with text phrases or information known to be near the geographic location specified in the geo-tag of the image. The text strings recognized in the image are compared with the phrases for the establishments for approximate matches, and an establishment is selected as the establishment in the image based on the approximate matches.

United States patent application US20140008436 shows a marker composed of several confocal circles, separate fool-proofing elements spaced from the focus of the circles, and encoding elements. Contours are extracted from an image which includes the marker. If the image is deformed either by the perspective of the position of the camera taking the image, or by curvature of the surface on which the image is placed, the marker's circles produce confocal conics. The system disclosed therein looks for the marker by detecting these confocal conics. Once detected, the confocal conics are then used to determine and correct the marker's deformation. The relative position of the fool-proofing elements to the circles is then used to correct the orientation of the marker. Data is then extracted from encoding elements present on the marker.

The use of confocal circles and the detection of and correction by confocal conics means that the marker is very limited in its design. The essential marker design is also very similar to existing shapes that may be present, meaning that the processing of an image rich environment can be inconvenient. Although the marker can be detected when it has been subjected to a certain amount of distortion, and the method may be able to compensated for the distortion after the detection to extract the encoded data, the marker is still vulnerable to distortion and background noise.

The present invention seeks to improve over each of the above documents by providing alternative and enhanced means of recognition and automatic image grouping.

### SUMMARY OF THE INVENTION

According to a first aspect, the present invention consists in a marker for use on physical objects in order to allow the marker to be identified and the objects classified by processing photographs or video frames taken of the objects, the marker comprising an image composed of at least two contrasting colours the image being based upon an image template including a number of shapes, whose edges form at least three separate, non-overlapping and non-crossing closed loop lines wherein
at least a first line encompasses at least a second line
at least a third line does not encompass at least a second line
the lines when considered as a whole are asymmetric
the lines of the marker include at least eight key features such as sharp corners and central points distributed across the marker in two dimensions
and wherein there are also included a number of secondary encoding features which may be arranged in a number of ways on the basic template of the marker to encode a unique ID.

According to a second aspect, the present invention consists in a method of detecting a marker according to any previous claim, comprising the steps of
receiving a photograph that may contain the image of the marker
generating lines from the edges of shapes of contrasting colour and/or brightness identifying any groups of lines
for at least one such identified group of lines determining one or more of the following characteristics of the lines picked from the group of how many lines encompasses other lines, how many lines do not encompass other lines, the hierarchy of the lines which do and don't encompass other lines, the number of key features such as sharp corners and central points on each line, the number of key features such as sharp corners and central points on all the lines, the shape of the lines, the relative positions of the lines, the relative sizes of the lines
   and comparing such characteristics with the stored characteristic corresponding to the basic template of the marker to identify it.

The invention further provides that a label can lie within the field of view of a photographic image, that the label can be identifiable within the photographic image, and that the image can bear a unique identifying code. The invention further provides provision of identification means operable to identifying the image of the label; adjusting means operable to adjust the image for flatness and size of presentation; and code reading means operable to read the unique identifying code from the adjusted image.

The invention further provides selected code receiving means operable to receive a selected unique identifying code; and photographic image acceptance means operable to accept a photographic image if the unique identifying code read from the adjusted image is the same as the received selected unique identifying code.

The invention further provides that the label can be provided in two or more different styles, the invention further comprising: label style indication receiving means operable to receive indication of the style of the label; label style identification means operable to identifying the style of the label in the photographic image; and conditional photographic image acceptance means operable to accept a photographic image only if the identified style of the label is the same as the received indicated label.

The invention also provides new label approach accepting means operable to receive an application to allocate a new label; and label code selection means operable to select an unused code to be employed in the new label.

The invention also provides label style selection means operable to select the style for the new label.

The invention also provides label image flip detection means employing the asymmetric element to detect if the label image is flipped; and label image flipping means operable flip the label image to provide correct label image face presentation.

The invention also provides that the label can comprise an asymmetric element, the system comprising label image rotational adjustment means operable rotationally to orientate the image of the label.

The invention further provides that the label can comprise a plurality of ordered code elements, presence or absence of a code element being indicative of a 1 or 0 in a sequence of binary digits representative of a binary number.

According to a third aspect, the present invention consists in label for inclusion in a photographic image, the label being displayable as at least one of: an adhesive label attached to an object; as a printed image incorporated into a billboard notice; painted or pasted on a vehicle; affixed on or within the surface of a product; printed in a book; applied to a garment; attached to a person; attached to a class of persons; incorporated in a banner; and affixed to a building.

The label of the third aspect also provides a plurality of code elements each capable to representing one digit in an ordered set of binary digits collectively representative of a binary number; and an asymmetrical element indicative of an orientation wherein an image of the label must be placed to identify and read individual code elements.

The system provides an image detection and decoding means that does not require special image capture equipment, but rather is intended to work on a wide variety of photographs and other images from existing general purpose cameras and other image capture devices. The robustness of the system allows both detection and decoding from images where the label may be present at varying distances (and so at varying sizes and resolutions), and varying alignment and distortion. This also allows pre-existing photographs, or photographs taken for different purposes, where there is no opportunity for real-time feedback, correction and rescanning of a marker, to be successfully processed for the presence of markers and their decoding.

### BRIEF DESCRIPTION OF THE DRAWINGS

The invention is further described, by way of examples, by the following description to be read in conjunction with the appended drawings, in which:

FIGS. 1A and 1B show an example of a first exemplary label that can be used in the present invention.

FIGS. 2A and 2B show another example of a label that can be used in the present invention.

FIGS. 3A to 3E show another example of a label that can be used in the present invention.

FIG. 4 shows an exemplary flow chart illustrating one possible method for a processor in a server or other computational machine to employ the labels to select photographic images for inclusion in a set of images relating to a specific events, locations, products, marketing campaigns, or persons.

FIG. 5 shows an exemplary flow chart illustrating the detail of one possible method of label detection

FIG. 6 shows an exemplary flow chart illustrating the detail of one possible method of label decoding

FIG. 7 is an exemplary block diagram illustrating an environment in which the present invention functions.

FIG. 8 is an exemplary block diagram illustrating possible contents of the image selecting server.

and

FIG. 9 is an exemplary flow chart illustrating one way in which an originating client can set up binary codes and styles of labels for an intended purpose.

### DETAILED DESCRIPTION

The invention will now be described by way of various examples and possible variations thereon.

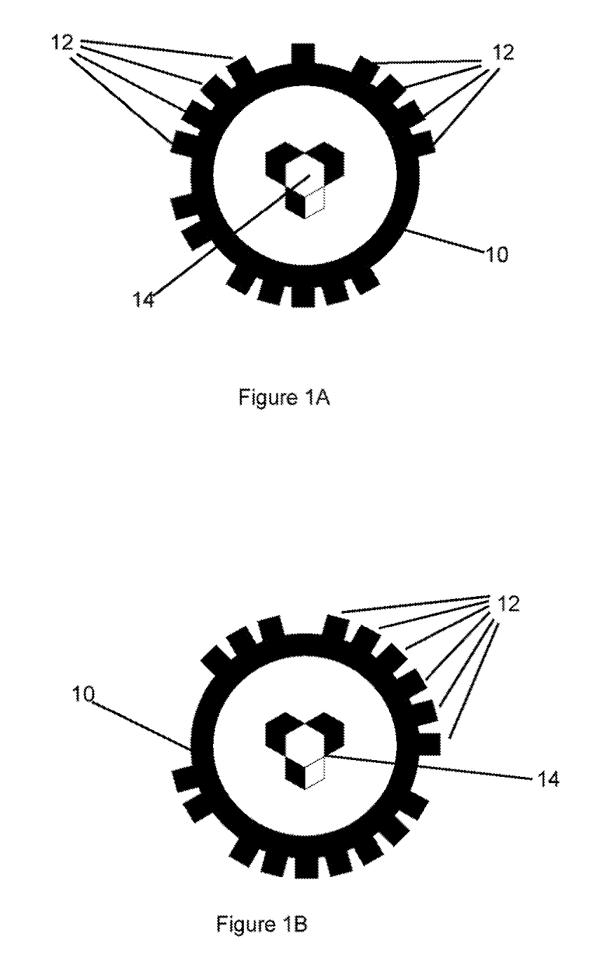

Attention is first drawn to FIGS. 1A and 1B, illustrating an exemplary first style of label 10 that can be employed in the present invention.

The label 10 comprises an automatically recognizable area. While the label 10 is shown in FIGS. 1A and 1n FIG. 1B as being generally circular, it is to be understood that the outline of each label 10 need not be circular nor symmetric in any way.

Each Label 10 is a high contrast label that can be printed on or adhered to materials, such as livery, merchandise or display materials, or otherwise made visible at a venue or event. The label 10 can be included anywhere in a scene where a photograph is taken. The purpose of the label 10 is to provide identification of one or more photographic images associated with a place, event or individuals. The label 10 can be large or small. For example, the label 10 can be incorporated into hoardings and billboards, or even attached to a building. The label 10 can also be attached to clothing and individuals. The label 10 can also be attached to vehicles. The size and disposition of the label 10 is not limited by the above examples. The label 10 can be disposed such that a photographic apparatus would catch an image of the label 10 at any angle and clearly enough so that the image of the label 10 can be processed and digital data contained there in can be decoded.

If the label 10 is printed at a diameter of 4-8 cm, optical image processing programs are able to recognise the label's presence and extract the code from imagery taken in a variety of conditions at distances of up to 5 m. If the label 10 is printed on posters, banners or other display material at larger sizes, as much perhaps as several meters in diameter, successful extraction from imagery captured is possible at much greater distances such as hundreds of meters or more.

The label 10 presents a large, consistent bold symbol specifically designed so that its presence can be easily visually recognised even at a distance and in a variety of orientations by feature detection algorithms such as, but not limited to, SIFT, SURF, ORB and FAST (clarified hereafter).

The label 10 also incorporates finer detail 12 in the form of code elements 12 in which a limited amount of data is encoded which can be extracted on deeper analysis of a label image. Each code element 12 represents a bit of data determined to have a value “1” or “0” dependently upon whether a particular code element 12 is present or absent from the label 10. In the example given in FIGS. 1A and 1B there are provided 24 code elements 12 allowing nearly 17,000,000 different separately identifiable label styles to be provided. This means that, with the arrangement shown, close to 17,000,000 different events, locations, products, marketing campaigns or persons can be identified by their respective labels. Those skilled in the art will be aware that different numbers of code elements 12 providing different numbers of binary digits can also be employed.

The label 10 also incorporates asymmetric element or elements 14 used by the label recognition and decoding program to orientate the detected image of the label 10 into a correct rotational position so that the code elements 12 fall into a predetermined orientation for their presence or absence to be detected to determine the binary number they represent. The binary number, having been extracted, can then be used, as will later be described, to determine whether or not a captured photographic image relates to a predetermined event, location, product, marketing campaigns or person(s).

FIGS. 1A and 1B show two examples of a first style of label each bearing a different binary code as expressed through their code elements 12.

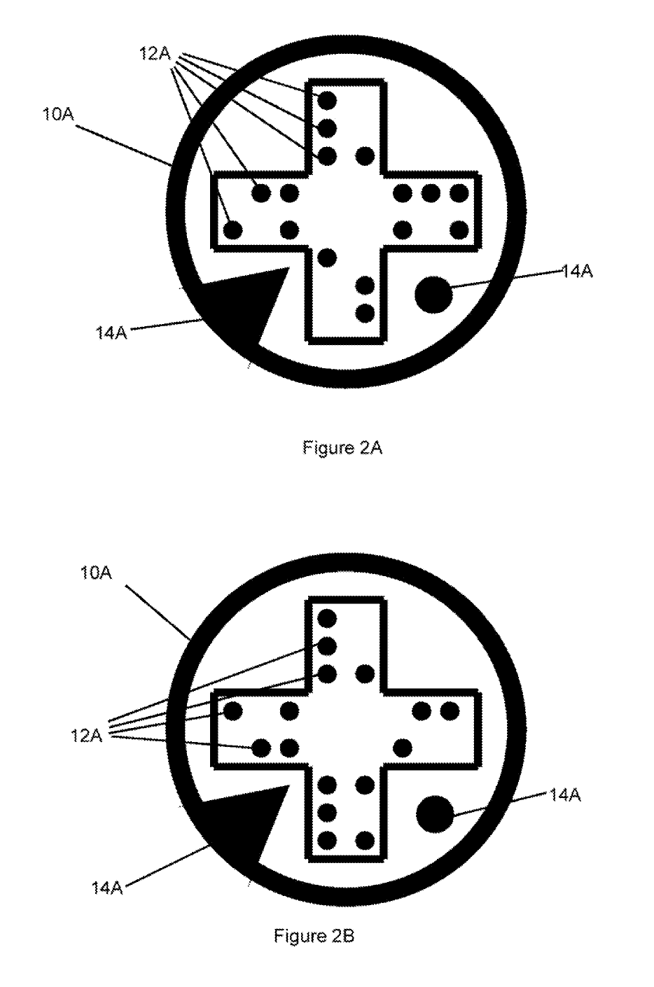

Attention is next drawn to FIGS. 2A and 2B showing possible second examples of a label 10A also suitable for use with the invention. In FIGS. 2A and 2B the label 10A is also generally circular in shape. The asymmetrical element 14A is provided in the form, in this instance, of a combination of a wedge and a circular blob asymmetrically disposed within the generally circular outline. The code elements 12A are provided, in this instance, as domino dots provided within a general domino form, there being four domino forms symmetrically arranged in a cross within the generally circular outline. As with the example of FIGS. 1A and 1B, 24 binary digits are provided whose value depends upon the presence or absence of domino dots.

Those skilled in the art will be aware that many different formats can be provided for the labels 10 10A. More or fewer than 24 binary digits can be provided. The label 10 10A can also have, as its asymmetrical element, a general asymmetry of outline.

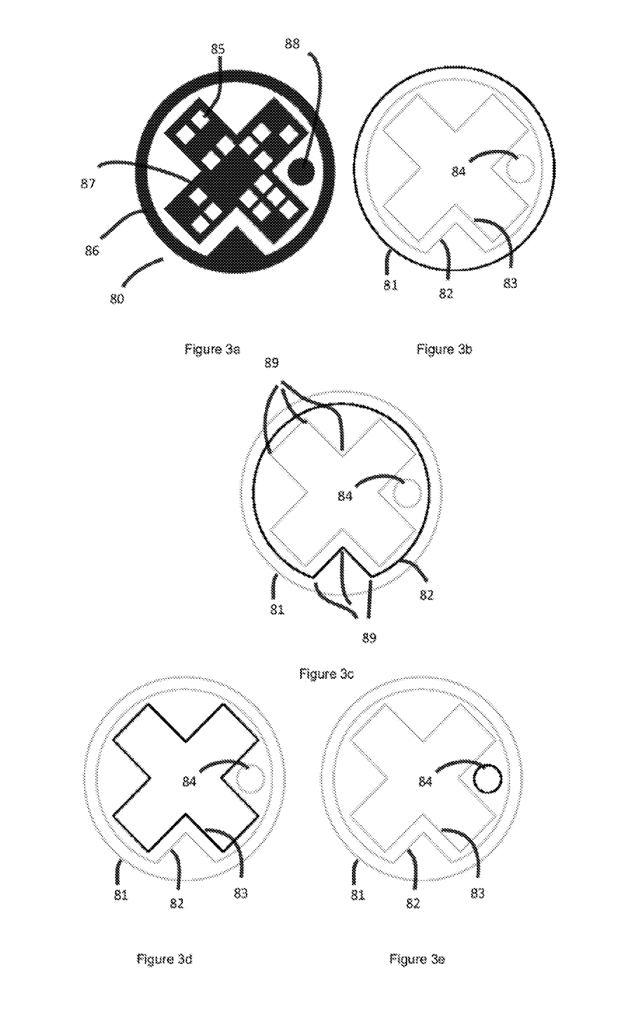

Both labels are designed to share some important characteristics. Referring now to FIGS. 3a to 3e, the label in 3a is designed with the same philosophy as the labels in FIGS. 1 and 2. The label includes an outer generally annular shape 86, an inner generally cruciform shape 87, and an inner circular shape 88. The thickness and nature of these shapes present a number of outlines or contours, ideally at least least four unbroken and non-crossing contours, arranged both concentrically and non-concentrically. The annular shape 86 provides both an outer circular contour 81 (shown in bold in FIG. 3b), and an inner partially circular contour 82 (shown in bold in FIG. 3c). The cruciform shape 87 provides a cruciform contour 83 (shown in bold in FIG. 3d), while the circular shape 88 provides a circular contour 84 (shown in bold in FIG. 3e). The cruciform shape also includes code elements 85.

These shapes, and the ID encoding features of the label, are arranged and sized so that the width and the spaces between them are at least 3% the diameter of the label. This is found to be the optimal spacing to allow an adequate number of features to be included in a label as small as 4-5 cm in diameter which could be easily included on a product, and for them to be distinguished from each other in an image captured at typical distances used for small group shoots and at an image resolution captured by commonly used photographic equipment. As the capabilities of equipment improves it is expected that this limit could be reduced. The shapes in the label are also designed to provide several distinctive key points, such as the corners 89 on the partially circular contour 82 and the cruciform shape 87. Ideally, at least eight of the points are provided by the label.

It will be noted that some of these contours, such as the outer circular contour 81 (shown in bold in FIG. 3b), the inner partially circular contour 82 (shown in bold in FIG. 3c) and the cruciform contour 83 (shown in bold in FIG. 3d) are arranged in a concentric formation. The circular contour 84 (shown in bold in FIG. 3e), while encompassed by the outer circular contour 81 and the inner partially circular contour 82, is not concentric with these shapes, and also lies outside and is not concentric with the cruciform contour 84. Thus there is a hierarchy of contours, such that some are concentric and others are not. Typically, there are four or more of these shapes.

As is described in greater detail below, when the label is being sought and analyzed, a convenient method is by using the technique of contour detection. The distribution of key points in the shapes or contours can be analyzed to indicate if the image in which the marker is found has been flipped/mirrored, and make the appropriate correction.

Common to all the examples is that the label includes a grouping of shapes (which during analysis provides a grouping of contour shapes) in a specific number, in a specific hierarchy (i.e. some shapes surrounding other, and some shapes not being surrounded by others), each contour having a specific shape, and a the contours having relative sizes.

The shape of the contour particularly means the presence and number of convexity defects, that is sharp inclusions into a shape, where sections of straight of smoothly curving lines meet at a corner or bend. The shape can also include other aspects, particularly the length of the lines (and their order and distribution) between such sharp inclusions. For optimal detection, the ideal number of contours appears to be three to seven inclusive.

Secondary features, such as the code element 85, are included. As for the labels in FIG. 1 and FIG. 2, these code features can conveniently be laid out in a general grid array, with certain sites occupied and other sites not occupied, in a way that can be translated into an ID. Enough sites are provided such that the number of combination can number thousands or millions, and it will be seen that various configurations of such code features, either incorporated within the major shapes or distributed about them, can perform this function. Colours may be used for the code elements to increase the data density.

As will become clear hereafter, one object of the design of the label is that its image can be restored substantially to a flat presentation and that its image can be rotated and, if necessary, flipped or reflected so that the asymmetrical element falls into a predetermined orientation allowing the binary number represented by the code elements 12 12A to be read.

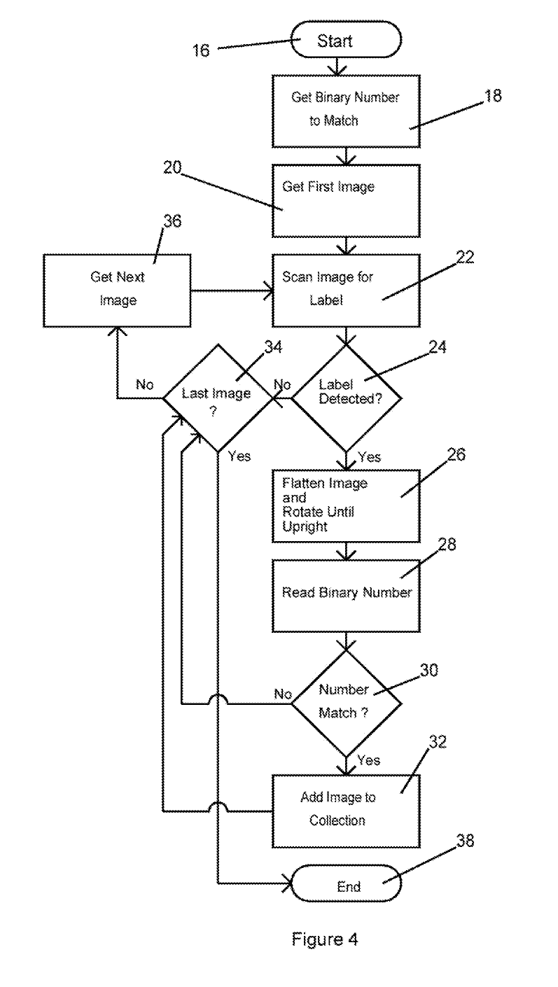

Attention is next drawn to FIG. 4, an exemplary flow chart illustrating one possible method for a processor in a server or other computational machine to employ the labels 12 to select photographic images for inclusion in a set of images relating to a specific events, locations, products, marketing campaigns, person or persons.

From a start 16 a first operation 18 has the processor receive and accept the binary number that will appear in images of the label 10 that the processor seeks to include in a collection of photographic images relating to a specified event, location, product, marketing campaign, person or persons (to provide a non-exhaustive list).

A second operation 20 then loads the first of one or more images to be checked. A third operation 22 then scans the loaded image to detect whether or not the image of a label 10 (by detecting the particular characteristics featured by the labels envisaged by this system) is present. The scanning preferably uses photographic image scanning software capable of recognising a label 10 image in whatever orientation it is presented in the photographic image. The image of the label can be obliquely viewed from below, from left or right or from above. Furthermore, the image of the label 10 may be rotated from its normal (upright) position. The label 10 image can also be viewed “flipped” i.e. viewed from behind from behind (as when, for example, the label 10 is presented inside a transparent surface such as a window) and also includes being viewed as a reflection. The scanning software must be capable of detecting an image of a label 10 in all of these conditions. Scanning software can include, but is not limited to: Scale Invariant Feature Transform (SIFT) algorithms; Speeded Up Robust Feature (SURF) detection; Oriented Brief (ORB); and FAST.

A first test 24 then checks to see if an image of a label 10 has been found.

If an image of the label 10 has been found, a fourth operation 26 adjusts the image of the label 10 in order for the processing equipment to read the binary number from the code elements 12. The adjustment of the label 10 includes vertical and/or horizontal scaling to cause the image of the label 10 to fit within a preselected boundary appearing to be viewed from immediately in front, and includes rotating the image of the label 10 until the asymmetric element 14 or elements are oriented in a predetermined orientation, and includes reflection of the image if the image is a flipped image as described above. The asymmetrical element 14 plays an important part in deciding whether or not an image is flipped. The sum of all of these processes render the image of the label 10 ready to have the binary number read from the code elements 12 12A.

It is to be appreciated that some or all of the image adjustments provided by the fourth operation 26 can be, instead, provided, in the whole or in part, by the third operation 22.

A fifth operation 28 then examines the code elements 12 12A to determine the binary number encoded within the label 10 10A. A second test 30 checks to see if the binary number recovered in the fifth operation 28 matches the binary number from the first operation 18. If a match is found, a sixth operation 32 has the inspected image to be stored as part of a collection of images related to the binary number signifying a particular event, location, product, marketing campaign, person or persons.

The sixth operation 32 passes control back to a third test 34 that checks to see whether or not the image is the last image of one or more images presented for testing. If the third test 34 finds that the image is not the last image, a seventh operation 36 gets the next photographic image to be tested and passes control to the third operation 22 to scan the newly selected image for an image of a label.

If the third test 34 finds that the previously tested image was the last image, the third test 34 passes control to an exit 38 to terminate operation.

If the first test 24 does not detect an image of a label 10, the first test 24 passes control to the third test 34 to check if the last image to be tested has been reached.

If the second test 30 does not detect a number match between the binary number that has been read by the fifth operation 28 and the binary number received in the first operation 18, the second test passes control to the third test 34 to check whether or not the final image has been reached.

The processes of FIG. 4 are given merely by way of example. Although FIG. 4 shows just one input binary number being at any one time, and only one collection of photographic images is made, it is to be understood that plural binary numbers can simultaneously be checked and one or more photographic image collections built up. It is also to be appreciated that the processes of FIG. 4 can scan for images of more than one label 10 at the same time and, if finding more than one label bearing more than one binary number, addition to plural photographic image collections can simultaneously be made.

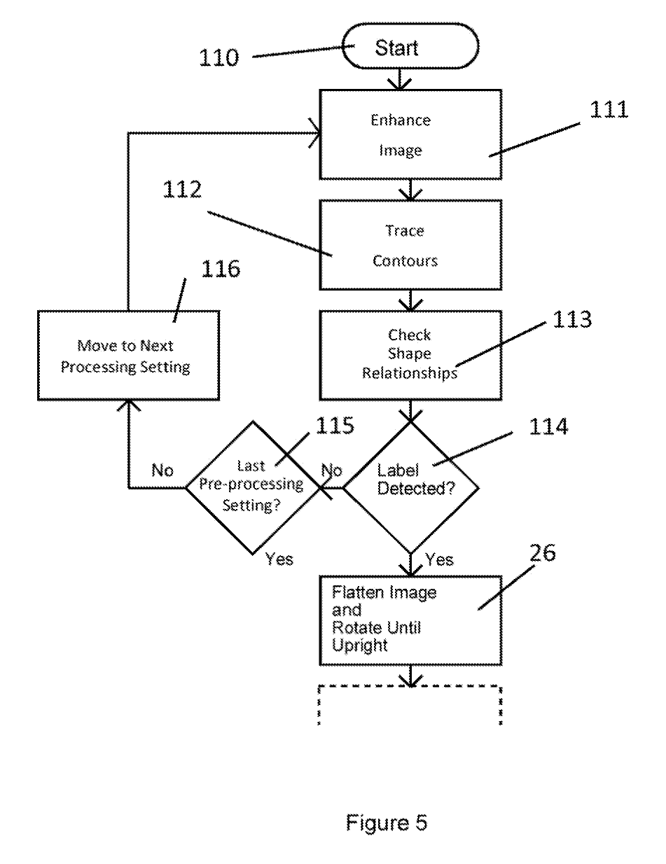

Referring to FIG. 5, a possible specific detection regime for an individual photograph is expounded. After the process is started 110, a first step 111 enhances the image. This may include normalising the lighting and contrast of the image, and noise reduction (such as a smoothing step). As a second step, the image is then analyzed by detecting contours in the image, specifically that of unbroken contours. This may be done using one or more of several known techniques. Where a label is present, this boundary lines generated by this step correspond to the contours such as those described in FIGS. 3b to 3e. Anomalous contours (such as those which are broken, crossing, or below a certain size or length) may be filtered out.

The third step 113 is to check the relationships of the shapes generated by the contour detection. This is done by checking for the correct number of contours, in the correct hierarchical arrangement, with the correct shape and relative sizes of the label or labels the system is seeking.

As previously described, the shape of the contour particularly means the presence and number of convexity defects, the nature and size of the lines between the convexity defects. The importance of these particular factors is their resilience to deformation. Using these parameters, a great variety of label styles can be produced and detected that are much more easily distinguished from commonly found structures and which are robust to distortion. The more contours employed, the easier it is to distinguish the label from background noise, but it also becomes harder to fit into a small space and remain distinguishable in an image of limited resolution as well as afford space for the encoding elements. As previously stated, the optimal number of contours appears to be between three and seven inclusive.

If a label is found 114, the image is flattened 26, and the code elements decoded to extract the ID as previously described in relation to steps 24 onwards shown in FIG. 4. Specifically the image may be distorted when it (and usually the surface upon which it is fixed) is not aligned directly in front of the camera, and the plane is not substantially parallel to the camera, but instead off-centre and/or inclined or tilted. Flattening as the term is used here then generally involves applying a corrective transformation as is known in the art. The flattening process may also include transformations to correct for the image being applied to a curved surface, and for to lens distortion, such as fisheye distortion.

The distortion is corrected by extracting and comparing the arrangement of key points, such as the convexity defects (for example, the number and spatial distribution of corners 89 shown in FIG. 3 on the partially circular contour 82 and the cruciform shape 87) to the original template.

It should be particularly noted that the factors used to detect the label (the contours) and the factors used to correct the label's deformation (the key points) are different. Using two different sets of features (though aspects of the two sets may be related) for detection and correction allows use much greater flexibility in label design. The optimal number of key points is much harder to define but they must be spread across the face of the label in order to correct for deformations across the label surface and the more there are the better the correction will be.

As with the contours, the intended minimum size of the marker will limit the number of key points that can be included.

The detected marker image (or the ID) is extracted and output with the necessary metadata to associate it with the original image/source. The steps involved in the process are set out in more details below.

If coloured labels or code elements are used, one of the steps, such as the reading of the binary number step 28, may include the separation of the image into separate colour channels to processes red, green and blue colour channels separately to improve detection of coloured elements.

The success of image enhancement can depend on what amount of adjustment contrast, brightness, smoothing etc. is carried out. One set of preselected values, or set of particular techniques, may work better for images taken under one set of conditions than images taken under a different set of conditions. If no label is detected, and some settings remain to be tried 115, a new selection of pre-processing settings may be chosen 116, and this process repeated with a variety of pre-processed settings to account for the widest range of lighting. Further, a photograph may include more than one label, and this repetition may detect different labels using different settings for a single photograph.

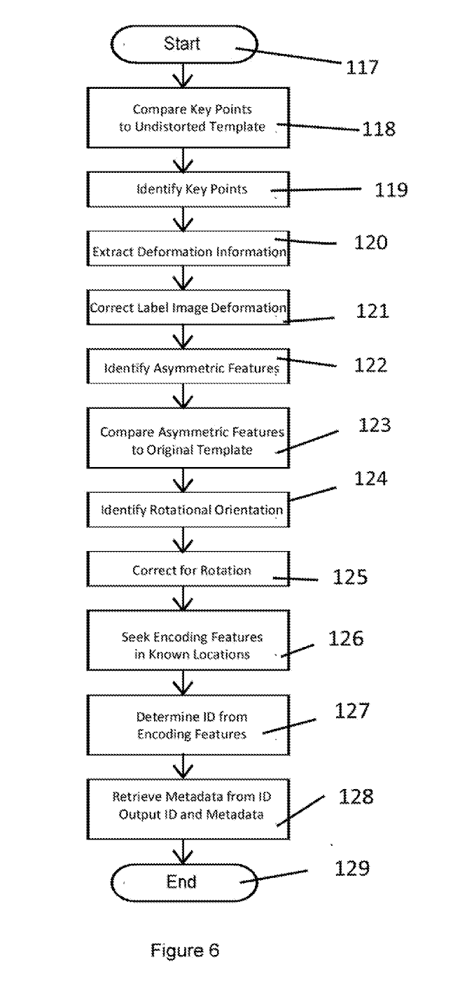

Referring to FIG. 6, a convenient sequence of specific steps of identifying a detected label and reading the coding elements are set out, corresponding to the more generally designated steps 26 and 28 in FIGS. 4 and 5. After the process is started 117, key points in the contours, such as angles and sharp corners, and the central points of contours are identified in the extracted label 118. The arrangement of these key points is compared to an undistorted template to extract deformation information 119. Using the template, the label is corrected for deformation 120, which will usually be a foreshortening in one direction from the label being photographed at an oblique angle, but other distortions may also be corrected for.

The asymmetric features are found and compared to those in original template in order to ascertain rotational orientation 124. For example, in the label shown in FIGS. 3a to 3e, the position of the corners 89 on the partially circular contour 82 in relation to the circular contour 84 have a particular orientation and angular position within the outer circular contour 81. Equally, reflection or flipping of the label can be detected. These features may then be used to correct or compensate for any rotation and reflection the image of the label has undergone 125.

Now that any deformation, rotation and reflection has been corrected, the encoding features may be sought in their known positions 126, and the ID of the label read 127. The metadata relating to the label is them retrieved using the ID, and is transmitted together with the original image or source 128. This ends the decoding process 129.

The detecting process described with reference to FIG. 5 and the decoding process described with reference to FIG. 6 are ideally carried by separate routines running in parallel, so that once the label is identified by the detection routine the contour information may be passed to the decoding routine; more ideally still, several detection routines and several decoding routines may be running in parallel, with resources allocated to match the throughput of the detection routines with the decoding routines. Both the decoding process and especially the detection process will take variable amounts of time to complete for an image, since the number of processing settings that are executed may vary. Separating and running the two routines in parallel ensures that resources are efficiently allocated and processing bottlenecks avoided, ensuring that the system can be scaled to process large numbers of images.

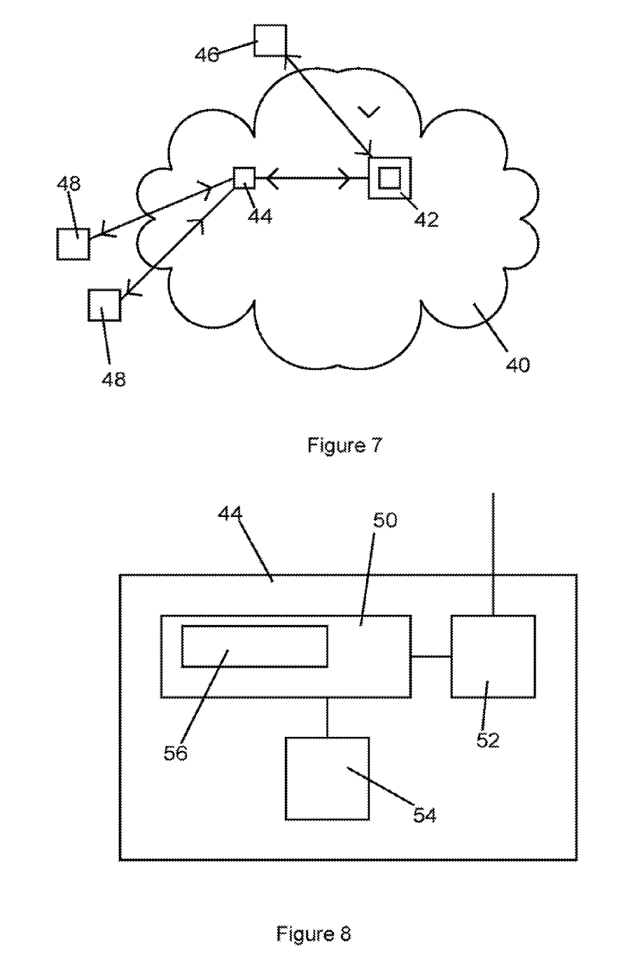

Attention is next drawn to FIG. 7, an exemplary block diagram illustrating the environment in which the present invention functions.

A network 40, preferably but not necessarily the Internet 40, hosts a plurality of websites servers (only two of which are here shown) including a code issuing server 42 and an image selecting server 44.

The code issuing server 42, as will hereafter be described, issues the code for the binary numbers to be presented in a label 10. The code issuing server 42 interacts with an originating client 46 to establish the basis for code issuance and to allocate another new code for the particular purpose designated by the originating client 46.

The image selecting server 44 operates as described with reference to FIG. 4. Within the invention, one or more viewing clients 48 interact either directly or indirectly with the image selecting server 44 to view image collections selected using the label 10 code. It is not part of the present invention to provide a type identity for the image selecting server 44. The image selecting server 44 can be, but is not limited to: a social network site; an investigative site; a corporate site; and editing site; a photo hosting site; a photo sharing site; a video hosting site; and a video sharing site.

The image selecting server 44 and the code issuing server 42 can also communicate with one another to provide indication of the selected code and style of label 10, together with details provided by the originating client.

Attention is next drawn to FIG. 8, an exemplary block diagram illustrating contents of the image selecting server 44.

The originating server 44 comprises a server processor 50 bidirectionally coupled to a modem 52 or other compunction device and/or setup that provides bidirectional coupling to the server processor 30 within the Internet 40.

The server processor 50 is coupled to a memory 54 where from it can retrieve photographic images and store selective photographic images. The server processor 50 operates under instruction from an image selecting server program 56 to achieve the purpose illustrated and described with reference to FIG. 4.

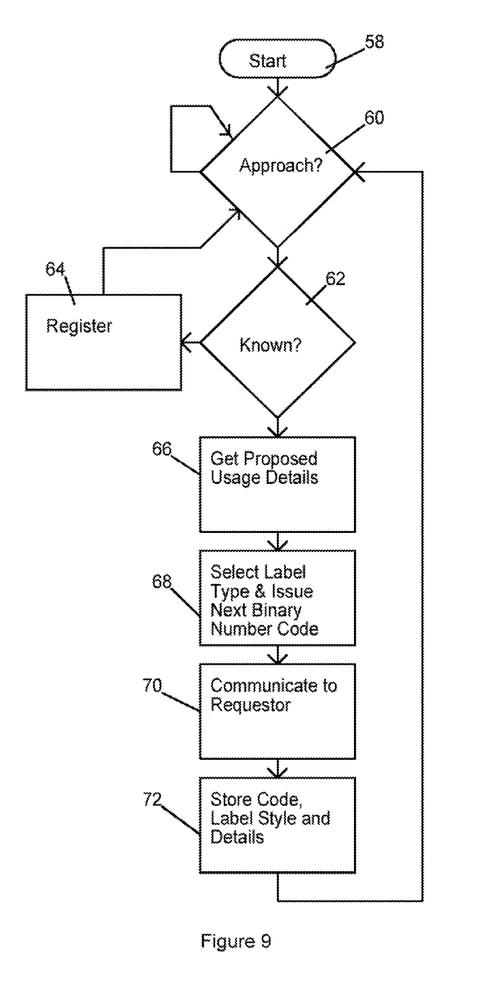

Attention is next drawn to FIG. 9, a flow chart illustrating one way in which an originating client 46 can set up binary codes and styles of labels for an intended purpose.

From a commencement 58 a fourth test 60 waits to detect an approach from an originating client 46. On approach from an originating client 46 a fifth test 62 checks to see if the client is known to the code issuing server 42. This can be done in various ways, such as checking whether login has been successfully achieved.

If the fifth test 62 finds that the originating client 46 is not known to the code issuing server 42, an eighth operation 64 conducts a new registration procedure and passes control back to the fourth test 60.

If the fifth test 62 finds that the customer is known to the code issuing server 42, a ninth operation 66 gatherers details of the proposed intended usage of images from the approaching customer. The label 10 may be used for any other reasons stated here before. Those skilled in the art will be aware of many other purposes to which identification of a label 10 in a photographic image may be applied.

A tenth operation 68 then selects the style of label 10 that is to be used (possibly under the direction of the customer), it being envisaged within the invention that many different styles of label 10 can be selected. Label 10 identification can, within the invention, also include identification of a particular style of label.

The tenth operation 68 also selects an unused binary code for use in association with the label. Where a plurality of label styles is employed, particular binary numbers can be issued a plurality of times without risk of confusion of identity.

The secondary graphical features for the particular style or styles of label are generated and applied to the common marker template for that style, the unique combination of which relates to the chosen ID.

An eleventh operation 70 then communicates the selected label 10 style and allotted binary number to the requesting client 46. The unique ID is also stored in the database in association with metadata related to the entity deploying the marker and/or the circumstances of its deployment. The specific marker design and/or the label types may also be stored.

The unique marker design assets are then communicated to the requesting client 46 the requesting client 46 so that it is then free to print labels 10 for application to one or all of the items described herein before. The requesting client 46 can also incorporate the selected label 10 with its allocated binary number into the surface of products.

A twelfth operation 72 then stores the label 10 style, allotted binary code, and details of the purpose of the label 10 for later communication when requested by others.

The twelfth operation 72 then passes control back to the fourth test 60 to await a fresh approach from an originating client 46.

The invention provides “visual metadata” for an event or other occasion in the form of an image of one or more labels 10 recorded in a photograph or video. The label 10 provides something visual that is introduced into the image, by for example, the organisation running an event or the maker of a product, to assist its later identification in photographic or video images. Alternate solutions rely on non-visual metadata, such as date and location, Use of metadata to identify an event relies on the person capturing and sharing this metadata reliably, which is not usually the case. “Visual Metatdata”, does not interfere with metadata such as an event time and place. The metadata can still be used if present. The embedding of an image of a label 10 provides a technical advantage in that the in-scene embedded label image 10 cannot become, lost, detached or obliterated, thereby avoiding fraudulent image use of photographic or video images and also avoiding loss of information. The “visual metadata” label image further provides a further technical improvement by allowing event etc information to be recovered directly from a photograph or video image.

After a photographic or video set of images has been extracted and stored using the label 10 image, the collected set of images may be examined and/or sent for examination and preview to the event (or other occasion) organisers to check for copyright or other infringement. As an alternative, only references to the photographic or video images may be sent for scrutiny and approval.

In the above example, the code issuing server 42 both encodes a unique ID to generate a label with coding elements for that ID, and stores the ID in relation to the metadata relating to the user of the label. The encoding functions and database storage functions may be provided together or separated to a greater or lesser extent. Typically, the system stores all unique marker ID and tag design/type combinations in a database together with metadata related to the entity deploying the marker and/or the circumstances of its deployment. This database can then provide metadata associated with an ID when provided with a valid ID (for example, when an ID from a label has been recovered), and check the availability of new Ids. Ideally, it will also store the label image or image reference in association with ID, and provide this when provided with a valid ID.

The invention has been described by means of a series of examples. It is to be appreciated that those skilled in the art will know of many variants and modifications that can be employed without deviating from the invention as claimed here below.

The invention is further clarified by the following appended claims.

1-16. (canceled)

17. A marker for use on physical objects in order to allow the marker to be identified and the objects classified by processing photographs or video frames taken of the objects, the marker comprising an image composed of at least two contrasting colours
the image being based upon an image template including a number of shapes, whose edges form at least three separate, non-overlapping and non-crossing closed loop lines wherein
at least a first line encompasses at least a second line
at least a third line does not encompass at least a second line
the lines when considered as a whole are asymmetric
the lines of the marker include at least eight key features such as sharp corners and central points distributed across the marker in two dimensions
and wherein there are also included a number of secondary encoding features which may be arranged in a number of ways on the basic template of the marker to encode a unique ID.

18. A marker according to claim 17, wherein the lines of the image is asymmetric both rotationally and reflectively.

19. A marker according to claim 17 wherein the encoding features are produced in more than two colours.

20. A marker according to claim 18, wherein the encoding features are produced in more than two colours.

21. A marker according to claim 17 wherein the width of the shapes and the spaces between them are at least 3% the diameter of the marker

22. A marker according to claim 18 wherein the width of the shapes and the spaces between them are at least 3% the diameter of the marker

23. A marker according to claim 19 wherein the width of the shapes and the spaces between them are at least 3% the diameter of the marker

24. A method of detecting a marker according to claim 17 comprising the steps of
receiving a photograph that may contain the image of the marker
generating lines from the edges of shapes of contrasting colour and/or brightness
identifying any groups of lines
for at least one such identified group of lines determining one or more of the following characteristics of the lines picked from the group of how many lines encompasses other lines, how many lines do not encompass other lines, the hierarchy of the lines which do and don't encompass other lines, the number of key features such as sharp corners and central points on each line, the number of key features such as sharp corners and central points on all the lines, the shape of the lines, the relative positions of the lines, the relative sizes of the lines
and comparing such characteristics with the stored characteristic corresponding to the basic template of the marker to identify it.

25. A method according to claim 24, wherein there is included the step of separating the photograph or the marker into different colour channels.

26. A method according to claim 24, wherein there is included the step of enhancing the photograph prior to generating lines from the edges of shapes.

27. A method according to claim 25 wherein there is included the step of enhancing the photograph prior to generating lines from the edges of shapes.

28. A method according to claim 24 wherein there is included the step of removing generated edges of anomalous size.

29. A method according to claim 25 wherein there is included the step of removing generated edges of anomalous size.

30. A method according to claim 26 wherein there is included the step of removing generated edges of anomalous size.

31. A method according to claim 27 wherein there is included the step of removing generated edges of anomalous size.

32. A method according to claim 26, wherein the step of enhancing the photograph is repeated with different settings.

33. A method according to claim 27, wherein the step of enhancing the photograph is repeated with different settings.

34. A method according to claim 30, wherein the step of enhancing the photograph is repeated with different settings.

35. A method according to claim 31, wherein the step of enhancing the photograph is repeated with different settings.

36. A method according to claim 24, wherein there is included the steps of
identifying key features such as sharp corners and central points
comparing identified key features to an undistorted template to extract deformation information
correcting image for deformation
seeking asymmetric features and compare to those in original template in order to ascertaining rotational orientation
correcting image for rotation
seeking presence or absence of encoding features in known locations
decoding encoding features to obtain image ID
and outputting the image ID.

37. A method according to claim 36, wherein there is included the step of retrieving metadata associated with original image/source using the image ID.

38. A method according to claim 36 wherein a first image and second image are processed simultaneously.

39. A method of processing a first image according to claim 36 while simultaneously receiving a photograph that may contain a second image of the marker
generating lines from the edges of shapes of contrasting colour and/or brightness from the second image
identifying any groups of lines from the second image
for at least one such identified group of lines from the second image determining one or more of the following characteristics of the lines picked from the group of how many lines encompasses other lines, how many lines do not encompass other lines, the hierarchy of the lines which do and don't encompass other lines, the number of key features such as sharp corners and central points on each line, the number of key features such as sharp corners and central points on all the lines, the shape of the lines, the relative positions of the lines, the relative sizes of the lines
and comparing such characteristics with the stored characteristic corresponding to the basic template of the marker to identify the second image.

40. A method according to claim 24 wherein there is included the step of seeking asymmetric features
reflecting the image if it is found that reflection of the photograph has taken place.

41. A method according to claim 36 wherein there is included the step of seeking asymmetric features
reflecting the image if it is found that reflection of the photograph has taken place.
